(19) United States
(12) Patent Application Publication
(10) Pub. No.: US 2010/0234480 A1
(43) Pub. Date: Sep. 16, 2010

(54) HYDROPHOBICALLY MODIFIED MELAMINE RESIN FOAM

(75) Inventors: Klaus Hahn, Kirchheim (DE); Vath Bernhard, Mannheim (DE); Armin Alteheld, Bad Kreuznach (DE); Christof Möck, Mannheim (DE); Horst Baumgartl, Mainz (DE)

Correspondence Address: CONNOLLY BOVE LODGE & HUTZ LLP, 1875 EYE STREET, N.W., SUITE 1100, WASHINGTON, DC, 20006, US

(73) Assignee: BASF SE, Ludwigshafen (DE)

(21) Appl. No.: 12/294,712

(22) PCT Filed: Mar. 22, 2007
(86) PCT No.: PCT/EP07/52727

§ 371 Date: Sep. 26, 2008

(30) Foreign Application Priority Data
Mar. 28, 2006 (EP) 06111796.6

(51) Int. Cl. C08J 9/224; C08J 9/06

(52) U.S. Cl. 521/94; 521/188

(57) ABSTRACT

It is an open-cell foam based on a melamine-formaldehyde condensation product and hydrophobicized with a compound comprising C₆-C₂₀-alkyl groups, in particular stearyl groups, such as aluminum stearate or stearyl isocyanate.

The present invention relates to a hydrophobicized open-cell foam based on a melamine-formaldehyde condensation product, processes for its production and also use.

Open-cell elastic foams based on melamine-formaldehyde resins and also processes for their production by heating with hot air, water vapor or microwave irradiation to expand and crosslink a blowable (containing a blowing agent) solution or dispersion of a melamine-formaldehyde precondensate are known and described for example in EP-A 17672 and EP-A 37470.

They are useful for various lagging and sound-absorbing applications in buildings and vehicles and also as an insulating and cushioning packaging material. Untreated melamine-formaldehyde foams are very quick to imbibe both hydrophilic and hydrophobic liquids. The imbibition of water can have an adverse effect on foam properties, for example raising the density or worsening the thermal insulation.

EP-A 633 283 discloses reducing the water imbibition in melamine-formaldehyde foams by coating the foam scaffold with a hydrophobicizing agent, in particular with an aqueous emulsion of a silicone resin. The examples utilize a foam having a density of 11 kg/m³, which is coated with a hydrophobicizing agent in an additional operation and has densities between 72 kg/m³ and 120 kg/m³ after hydrophobicization. The raised density can mean disadvantages compared with the unmodified melamine-formaldehyde foam in some areas of application, for example for applications in the transportation sector, such as aircraft. In addition, the advantageous properties of the melamine-formaldehyde foam with regard to thermal stability and low flammability can be worsened by the high proportion accounted for by coating. The exemplified water imbibition of above 20% by volume for the hydrophobicized materials is comparatively high and sufficient to adversely affect the properties of the material. Common hydrophobicizing agents, such as the recited silicones or chloroprenes, are mostly soluble in many organic solvents or swell. Therefore, contact with organic solvents can lead to detachment of the hydrophobicizing layer or to swelling through imbibition of the solvent, which is costly or time intensive to remove.

DE-A 100 11 388 describes an open-cell melamine resin foam whose cell scaffold is coated with a fluoroalkyl ester hydrophobicizing and oleophobicizing agent. Oil imbibition on the part of the melamine resin foam is reduced as well as its water imbibition.

It is an object of the present invention to provide an open-cell foam that is based on a melamine-formaldehyde condensation product, has both hydrophobic and oleophilic properties and is simple to produce. The modified open-cell foam should be useful in particular for liquid-liquid separation and also as a leak guard for oil tanks.

We have found that this object is achieved by an open-cell foam based on a melamine-formaldehyde condensation product and hydrophobicized with a compound comprising C₆-C₂₀-alkyl groups.

The open-cell foam is preferably hydrophobicized with a compound comprising stearyl groups.

It is advantageous for the hydrophobicizing effect to be achievable with a minimal increase in the density of the foam. Hydrophobicizing agents which are not detached from the foam on contact with organic solvents are particularly suitable since they are fixed on the surface by covalent chemical attachment or a crosslinking reaction for example. Further advantageous hydrophobicizing agents are substances which may be added to the recipe before the reaction mixture is expanded and have only a minimal influence on foam structure and foam mechanicals.

Open-Cell Foam:

The envelope density of the open-cell foam is generally in the range from 3 to 100 g/l and preferably in the range from 5 to 20 g/l. The cell count is typically in the range from 50 to 300 cells/25 mm. The tensile strength is preferably in the range from 100 to 150 kPa and the breaking extension in the range from 8 to 20%.

To produce an open-cell foam based on the melamine-formaldehyde (MF) resin preferred as amino resin, a highly concentrated melamine-formaldehyde precondensate solution or dispersion comprising blowing agent can be expanded with hot air, water vapor or by microwave irradiation and cured as described in EP-A 071 672 or EP-A 037 470.

To effect the hydrophobicization of the present invention, the open-cell foam thus obtained can be sprayed or drenched with a liquid reaction mixture, a solution or aqueous dispersion of a C₆-C₂₀-alkyl isocyanate, preferably stearyl isocyanate, by gas phase deposition and subsequently be hydrophobicized at a temperature in the range from 40 to 200° C. The isocyanate reacts with remaining methylol groups and amino groups on the surface of the cell struts of the open-cell melamine-formaldehyde foam to form a urethane group or a urea group, respectively. The reaction is preferably speeded by addition of a catalyst.

Alternatively, the hydrophobicization of the foam can also be hydrophobicized by nonreactive C₆-C₂₀-alkyl-comprising compounds, for example salts of stearylic acid, such as aluminum stearate, sodium stearate, calcium stearate or zinc stearate. A mixture comprising a melamine-formaldehyde (MF) precondensate, a hardener and a blowing agent may be admixed with 0.1% to 10% by weight and preferably 1% to 5% by weight, based on mixture solids, of stearate and the mixture subsequently heated to expand and crosslink. This alternative process has the advantage of requiring no additional processing steps, such as drenching in a dispersion, expressing liquid from the foam and drying at elevated temperature. The addition makes it possible to obtain hydrophobic foams having comparable densities to nonhydrophobicized foams.

Hydrophobicizing agents used are preferably aluminum stearates and more preferably aluminum monostearate, since no significant change in foam structure and foam mechanical properties was observed with their use and the foams obtained are elastic.

This process proceeds from a melamine-formaldehyde precondensate. Melamine-formaldehyde condensation products, as well as melamine, may comprise up to 50% and preferably up to 20% by weight of other thermoset-formers and, as well as formaldehyde, up to 50% and preferably up to 20% by weight of other aldehydes in cocondensed form. Particular preference is given to an unmodified melamine-formaldehyde condensation product. Useful thermoset-formers include for example alkyl- and arylalkyl-substituted melamine, urea, urethanes, carboxamides, dicyan-diamide, guanidine, sulfurylamide, sulfonamides, aliphatic amines, glycols, phenol and its derivatives. Useful aldehydes include for example acetaldehyde, trimethylol-acetaldehyde, acrolein, benzaldehyde, furfural, glyoxal, glutaraldehyde, phthalaldehyde and terephthalaldehyde. Etherified precondensates of aldehyde resins are also useful. Further details concerning melamine-formaldehyde condensation products are to be found in Houben-Weyl, Methoden der organischen Chemie, Volume 14/2, 1963, pages 319 to 402.

The molar ratio of melamine to formaldehyde is generally less than 1:1.0, preferably between 1:1 and 1:5 and especially between 1:1.3 and 1:1.8. According to EP-B 37470, the melamine resins advantageously comprise sulfite groups in cocondensed form, as can be accomplished for example by addition of 1% to 20% by weight of sodium hydrogensulfite in the course of the condensation of the resin. It has emerged that a relatively high sulfite group content for a constant melamine to formaldehyde ratio results in a higher formaldehyde emission of the foam. The precondensate used should therefore comprise virtually no sulfite groups, i.e., the sulfite group content should be below 1%, preferably below 0.1% and especially 0%.

An emulsifier or emulsifier mixture has to be added to emulsify the blowing agent and to stabilize the foam. The emulsifier used can be anionic, cationic and nonionic surfactants and mixtures thereof.

Useful anionic surfactants are diphenylene oxide sulfonates, alkane- and alkylbenzene-sulfonates, alkylnaphthalenesulfonates, olefinsulfonates, alkyl ether sulfonates, fatty alcohol sulfates, ether sulfates, alpha-sulfofatty acid esters, acylaminoalkane-sulfonates, acylisethionates, alkyl ether carboxylates, N-acylsarcosinates, alkyl- and alkyl ether phosphates. Useful nonionic surfactants include alkylphenol polyglycol ethers, fatty alcohol polyglycol ethers, fatty acid polyglycol ethers, fatty acid alkanolamides, EO-PO block copolymers, amine oxides, glyceryl fatty acid esters, sorbitan esters and alkyl polyglucosides. Useful cationic emulsifiers include alkyl-triammonium salts, alkylbenzyldimethylammonium salts and alkylpyridinium salts. The emulsifiers are preferably added in amounts of 0.2 to 5% by weight, based on the resin.

To generate a foam from the melamine resin solution, the solution has to comprise a blowing agent, the amount depending on the density desired for the foam. In principle, the process of the present invention can utilize not only physical but also chemical blowing agents. Useful physical blowing agents include for example hydrocarbons, halogenated, in particular fluorinated, hydrocarbons, alcohols, ethers, ketones and esters in liquid form or air and CO₂ as gases. Useful chemical blowing agents include for example isocyanates mixed with water (releasing CO₂ as the effective blowing agent), carbonates and bicarbonates mixed with acids which likewise generate CO₂ and also azo compounds, such as azodicarbonamide. In one preferred embodiment of the present invention, the aqueous solution or dispersion includes between 1% and 40% by weight, based on the resin, of a physical blowing agent having a boiling point between 0 and 80° C.; for pentane the amount is preferably in the range from 5% to 15% by weight.

The curing agents employed are azidic compounds which catalyze the further condensation of the melamine resin. The amounts are between 0.01% and 20% and preferably between 0.05% and 5% by weight, based on the resin. Useful curing agents include inorganic and organic acids, examples being hydrochloric acid, sulfuric acid, phosphoric acid, nitric acid, formic acid, acetic acid, oxalic acid, toluenesulfonic acids, amidosulfonic acids and also acid anhydrides.

For some purposes it can be beneficial to include up to 20% by weight and preferably less than 10% by weight, based on the resin, of customary additives, such as dyes, flame retardants, UV stabilizers or fibrous fillers, agents to reduce combustion gas toxicity or to promote carbonization.

In addition to the hydrophobicizing agents of the present invention, it is possible to add further hydrophobicizing agents in amounts of 0.2% to 5% by weight. Useful hydrophobicizing agents include for example silicones, paraffins, silicone surfactants, fluorosurfactants, hydrophobic hydrocarbonaceous surfactants, silicone and fluorocarbon emulsions.

The concentration of the melamine-formaldehyde precondensate in the mixture of precondensate and solvent can vary within wide limits between 55% and 85% and preferably between 63% and 80% by weight. The preferred viscosity for the mixture of precondensate and solvent is between 1 and 300° dPas and preferably between 5 and 2000 dPas.

The hydrophobicizing agents of the present invention and additives may be mixed homogeneously with the aqueous solution or dispersion of the melamine resin, the blowing agent being forced in under pressure if appropriate. However, it is also possible to proceed from a solid, for example spray-dried, melamine resin and to mix it with an aqueous solution of the emulsifier, with the curing agent and with the blowing agent. The mixing of the components can be carried out in an extruder for example. After mixing, the solution or dispersion is discharged through a die and immediately thereafter heated to expand it.

The heating of the blowable solution or dispersion can in principle be effected by means of hot gases or high frequency irradiation, as described in EP-B 17671. But preferably the necessary heating is done by using ultra-high frequency irradiation as described in EP-B 37470. This dielectric radiation can in principle employ microwaves in the frequency range from 0.2 GHz to 100 GHz. For industrial operation, frequencies of 0.915, 2.45 and 5.8 GHz are available, among which 2.45 GHz is particularly preferred. The source for dielectric radiation is the magnetron, although a plurality of magnetrons may also be used for irradiation at the same time. Care must be taken to ensure that the irradiating is done with a very uniform field distribution.

The irradiating is advantageously carried out in such a way that the power taken up by the solution or dispersion is between 5 and 200 and preferably between 9 and 120 KW, based on 1 kg of water in the solution or dispersion. If the power taken up is less, foaming no longer occurs and the mixture merely cures. Within the preferred range, the foaming rate of the mixture increases with the power uptake. Above about 200 KW per kg of water, the foaming rate no longer increases significantly.

The mixture to be blown is irradiated immediately on emerging from the foaming die. The mixture, which is in the process of foaming up as a consequence of temperature increase and blowing agent vaporization, is applied to circulating belts which form a rectangular duct to shape the foam.

Foams based on a melamine-formaldehyde condensation product of low formaldehyde emission can be produced as described in WO 01/94436 using an MF precondensate having a melamine to formaldehyde molar ratio of greater than 1:2. To achieve very low formaldehyde emissions, the foam can be annealed at 220° C. for 30 minutes after drying. After annealing, however, the foams are in a cured state and no longer thermoformable.

To improve their performance characteristics, the foams can be subsequently annealed and pressed as described in EP-B 37470 for example. The foams can be cut to the desired shape and thickness and laminated on one or both sides with covering layers. A polymer film or metal foil can be applied as covering layer for example.

The foams can be produced as sheets or webs up to 2 m in height or as films a few mm in thickness. The preferred foam height (in the foam rise direction) is between 50 cm and 150 cm for 2.45 GHz microwaves. All desired sheet or film thicknesses can be cut out of such foam webs. The foams can be laminated on one or both sides with covering layers, for example with paper, board, glass overlay mat, wood, plasterboard, metal sheet or foil, plastic film, which may each also be in a foamed state if appropriate.

One field of use for the foams produced according to the present invention is thermal and acoustic insulation of buildings and parts of buildings, in particular partitions, but also roofs, facades, doors and floors, and also thermal and acoustic insulation of land, air and sea vehicles and also low-temperature insulation, for example of refrigerated warehouses, oil tanks and liquefied gas containers.

Further applications are the use as insulating wall cladding and as insulating and shock-absorbing packaging material. Owing to the substantial hardness of crosslinked melamine resins, the foams can also be used for slightly abrasive cleaning, grinding and polishing sponges.

The open-cell structure of the foams additionally makes it possible for suitable cleaning, grinding and polishing media to be taken up and stored in the interior of the foams.

When proceeding from low-formaldehyde precondensates, the foams of the present invention are also useful in the hygiene sector, for example in the form of thin fleeces as a wound dressing or as a constituent of infant diapers and incontinence products.

Owing to the elasticity of the open-cell foam, it is simple to insert it as insulation into prefabricated parts of a container. The foam remains elastic even at low temperatures, for example below −80° C. There is no damage due to embrittlement. It is therefore also particularly useful for flexible insulation of flexible pipework, for example for liquid nitrogen filling hoses.

It is particularly preferable for the hydrophobicized open-cell foam of the present invention to be used by virtue of the hydrophobicization-enhanced leak protection and spillage protection as a liquid-reservoir for a power-fuel tank, an oil tank, a tank container for tanker vehicles, tanker trailers or tanker ships. The open-cell foam may be installed inside the tank container or else be mounted as a jacket around the tank container to act as a spillage guard. A liquid tank packed with the hydrophobicized open-cell foam of the present invention and filled with a hydrophobic liquid is found to be distinctly less prone to leak the liquid in a hydrophilic environment than the unmodified foam. For example, an oil tanker where a leak has occurred will leak distinctly less oil into the ocean than a tanker packed with an unmodified foam.

The hydrophobicized open-cell foam of the present invention is further used as a filter insert or separating medium for liquid-liquid separation whereby in the case of, for example, two-phase mixtures of liquids differing in hydrophilicity one component can be imbibed selectively because it corresponds approximately to the hydrophilicity of the foam. For example, a leaked water-insoluble hazardous material can be imbibed selectively. By combining unmodified and hydrophobicized foams it is possible to achieve liquid-liquid separations. It can be advantageous to combine a plurality of elements of this kind in order that the effect may be amplified.

### EXAMPLES

### Example 1

### Hydrophobicization with Stearyl Isocyanate

In a glass flask, 10 cube-shaped specimens (10*10*10 mm) of an open-cell melamine-formaldehyde foam having a density of 9 kg/m³ (Basotect ®, BASF AG) were drenched with a solution of 17.5 g of stearyl isocyanate in 332.5 g of toluene, to which 5 drops of a catalyst (Lupragen N 201, BASF AG, 33% solution of triethylenediamine in dipropylene glycol) had been added. The solution with the drenched foam cubes was refluxed at 80° C. for 8 h. The toluene solution was subsequently decanted off. The foam cubes were squeezed out to remove the bulk of the imbibed liquid and dried to constant weight. The density of the modified foam specimens is 18.5 kg/m³. The modified foam floats on water and is not noticeably wetted by water, the water imbibition is below 5% by volume.

The covalent attachment of stearyl isocyanate to form urethane or urea groups was demonstrated by infrared absorption spectroscopy (IR). There were no typical isocyanate bands, which would indicate unconverted stearyl isocyanate. The foam structure observed under a scanning electron microscope (SEM) and the associated mechanical properties were not affected by the modification.

The cube-shaped specimens of modified and unmodified foam were attached to a rod and dipped in stained toluene for comparison. Both the foam specimens were quick to imbibe the toluene completely. The toluene was stained with a dye (Thermoplast Blau 684 anthraquinone dye from BASF AG) is readily soluble in toluene but insoluble in water. The dipped specimens were subsequently placed in a water-filled vessel and mechanically agitated in the water by means of a rod doing a stirring movement. The bulk of the toluene was displaced by water in the unmodified foam, whereas the hydrophobicized foam retained toluene in the interior of the foam.

### Examples 2 and 3

### Hydrophobicization by Means of Aluminum Stearates

To produce a modified melamine resin foam by simultaneous hydrophobicization and foaming, the process exemplified in WO 0194436 was repeated. Before the blowable melamine-formaldehyde precondensate was foamed, an additional 2% by weight of aluminum tristearate (Example 2) or 2% by weight of aluminum monostearate (dihydroxyaluminum stearate) (Example 3) based on solids was added. The foams obtained were initially dried at 100° C., some materials were subsequently annealed at 180° C. for 5 h in order that the effect of annealing on hydrophobicization may be assessed.

### Examples 4 to 6 and comparative tests V1 and V2

Example 2 was repeated except that instead of an aluminum stearate no addition was made (V1) or 2% by weight of sodium stearate (Example 4), calcium distearate (Example 5), zinc distearate (Example 6) or aluminum diacetate (V2) was added:

The added aluminum stearates were not observed to have any effect on the density of the foams obtained.

The foam specimens obtained were repeatedly compressed (flexed) in some instances to destroy any cell membranes present which might lead to a reduction in water imbibition.

Hydrophobicity was determined by placing cube-shaped specimens of the foams (3 cm*3 cm*3 cm) on a water surface. Floatability and water imbibition were determined gravimetrically after 30 min. The results of the experiments and an assessment of elasticity of the materials following manual examination are depicted in Table 1.

TABLE 1

| | | | Water | Water | |
|---|---|---|---|---|---|
| | | | imbibition | imbibition | |
| | | | without | after annealing | |
| | | Float- | annealing | (180° C., 5 h) | Elas- |
| Example | Additive | ability | Vol % | Vol % | ticity |
| Ex. 2 | Aluminum | floats | 20.0 | 4.1 | + |
| unflexed | tristearate | | | | |
| Ex. 2 | Aluminum | floats | 40.4 | 11.1 | + |
| flexed | tristearate | | | | |
| Ex. 3 | Aluminum | floats | 2.2 | 1.5 | + |
| unflexed | monostearate | | | | |
| Ex. 3 | Aluminum | floats | 2.2 | 1.5 | + |
| flexed | monostearate | | | | |
| V1 | — | sinks | >99 | >99 | + |
| unflexed | | | | | |
| V1 | — | sinks | >99 | >99 | + |
| flexed | | | | | |
| Ex. 4 | Sodium | floats | n.d. | n.d. | − |
| unflexed | stearate | | | | |
| Ex. 5 | Calcium | floats | n.d. | n.d. | − |
| unflexed | distearate | | | | |
| Ex. 6 | Zinc | floats | n.d. | n.d. | − |
| unflexed | distearate | | | | |
| V2 | Aluminum | sinks | n.d. | n.d. | + |
| unflexed | diacetate | | | | |

n.d. : not determined
Evaluation of elasticity: + elastic, − brittle

The open-cell foams of Examples 1 and 2 have a comparable elasticity to comparative test V1. The foams produced by addition of aluminum monostearate and aluminum tristearate float, unlike the melamine-formaldehyde foam without additives. Water imbibition is further reduced by supplementary annealing of the material.

The water imbibition of the material produced using aluminum monostearate is not significantly affected by flexing, evidence against the formation of unwanted membranes in the foam.

Foams produced using stearates with other cations (Examples 4 to 6) likewise float, but their elasticity is less than in Examples 2 and 3.

Comparative experiment V2 shows that addition of aluminum salts of carboxylic acids having a distinctly smaller alkyl group than stearyl can provide foams of good flexibility, but their hydrophobicity is lower.

### Example 7

### Use for Liquid-Liquid Separation

A drop of stained toluene is introduced into water. The dye used is readily soluble in toluene (Thermoplast Blau 684 anthraquinone dye from BASF AG), but insoluble in water. The open-cell melamine-formaldehyde foam hydrophobicized according to Example 1 sucked up the stained toluene phase selectively, and is not wetted by the aqueous phase. On addition of an unmodified Basotect® cube, not only the stained toluene but also water was imbibed in the foam.

### Example 8

### Use for Liquid-Liquid Separation

An open-cell melamine-formaldehyde foam cut hydrophobicized according to Example 1 was placed on the frit insert of a glass filter frit and a chloroform-water mixture whose aqueous phase had been selectively colored (with Basantol Blue 762 liquid copper phthalocyanine complex from BASF AG) for identification was applied. The chloroform phase (higher density) was separated from the aqueous phase and passed through the frit, whereas the aqueous phase remained stagnant above the frit.

When the corresponding comparative test was carried out with an unmodified Basotect® cut, the chloroform-water mixture passed through the frit.

### Example 9

A Y-shaped glass tube about 1 cm in diameter was secured with two openings pointing down and one opening pointing up. One of the downwardly directed portions of the tube was packed with unmodified melamine-formaldehyde foam. The other portion of the tube was packed with a foam hydrophobicized according to Example 1. Both the foam packings extended into that portion of the Y-shaped tube where the three component tubes met.

Some water was initially introduced through the top opening. The water was taken up by the unmodified foam. Then, some toluene was introduced into the glass tube through the upper end, and was taken up by the hydrophobicized foam.

Selectively stained water (Basantol Blue 762 liquid copper phthalocyanine complex dye from BASF AG) and approximately the same amount of toluene were introduced into a glass beaker. Chloroform was added to the mixture in increments until the density of the colorless organic phase and the density of the colored aqueous phase had become so alike that complete separation of the mixture into two phases only occurred at least seconds after the mixture was stirred. The liquid mixture was stirred again and was immediately applied to the packed glass tube. The liquid mixture was observed to have become separated in the glass tube. The stained aqueous phase exited via the portion packed with unmodified foam, while the colorless organic phase exited via the portion of the tube containing hydrophobicized foam.

1. An open-cell foam based on a melamine-formaldehyde condensation product having a specific envelope density in the range from 3 to 100 g/l and hydrophobicized with a compound comprising C₆-C₂₀-alkyl groups.

2. The open-cell foam according to claim 1 hydrophobicized with a compound comprising stearyl groups.

3. The open-cell foam according to claim 1 having a specific envelope density in the range from 5 to 20 g/l.

4. The open-cell foam according to claim 1 produced from a melamine-formaldehyde condensation product having a melamine/formaldehyde molar ratio in the range from 1:1 and 1:5.

5. A process for producing an open-cell foam according to claim 1, which comprises the open-cell foam being sprayed or drenched with a solution of a Cₛ-C₂₀-alkyl isocyanate and hydrophobicized at a temperature in the range from 40 to 200° C.

6. A process for producing an open-cell foam according to claim 1, which comprises a mixture comprising a melamine-formaldehyde (MF) precondensate, a hardener and a physical blowing agent having a boiling point between 0 and 80° C. being admixed with 0.1% to 10% by weight, based on the solids content of the mixture, of aluminum stearates and subsequently heated with expansion and crossl inking.

7. The process according to claim 6 wherein the melamine/formaldehyde molar ratio of the precondensate is in the range from 1:1 to 1:5.

8. The method of preventing a spill comprising installing the open-cell foam according to claim 1 as a liquid-reservoir for a power-fuel tank, an oil tank, a tank container for tanker vehicles, tanker trailers or tanker ships.

9. The method off filtering a liquid comprising using the open-cell foam according to claim 1 as a filter insert.

10. The method of separating a two-phase mixture comprising using the open-cell foam according to claim 1 as a separating medium for liquid-liquid separation.

11. The method of taking up spilt organic liquids comprising using the open-cell foam according to claim 1 as a liquid reservoir.

12. The open-cell foam according to claim 2 having a specific envelope density in the range from 5 to 20 g/l.

13. The open-cell foam according to claim 2 produced from a melamine-formaldehyde condensation product having a melamine/formaldehyde molar ratio in the range from 1:1 and 1:5.

14. The open-cell foam according to claim 3 produced from a melamine-formaldehyde condensation product having a melamine/formaldehyde molar ratio in the range from 1:1 and 1:5.

15. A process for producing an open-cell foam according to claim 2, which comprises the open-cell foam being sprayed or drenched with a solution of a C₆-C₂₀-alkyl isocyanate and hydrophobicized at a temperature in the range from 40 to 200° C.

16. A process for producing an open-cell foam according to claim 3, which comprises the open-cell foam being sprayed or drenched with a solution of a C₆-C₂₀-alkyl isocyanate and hydrophobicized at a temperature in the range from 40 to 200° C.

17. A process for producing an open-cell foam according to claim 4, which comprises the open-cell foam being sprayed or drenched with a solution of a C₆-C₂₀-alkyl isocyanate and hydrophobicized at a temperature in the range from 40 to 200° C.

18. A process for producing an open-cell foam according to claim 2, which comprises a mixture comprising a melamine-formaldehyde (MF) precondensate, a hardener and a physical blowing agent having a boiling point between 0 and 80° C. being admixed with 0.1% to 10% by weight, based on the solids content of the mixture, of aluminum stearates and subsequently heated with expansion and crosslinking.

19. A process for producing an open-cell foam according to claim 3, which comprises a mixture comprising a melamine-formaldehyde (MF) precondensate, a hardener and a physical blowing agent having a boiling point between 0 and 80° C. being admixed with 0.1% to 10% by weight, based on the solids content of the mixture, of aluminum stearates and subsequently heated with expansion and crosslinking.

20. A process for producing an open-cell foam according to claim 4, which comprises a mixture comprising a melamine-formaldehyde (MF) precondensate, a hardener and a physical blowing agent having a boiling point between 0 and 80° C. being admixed with 0.1% to 10% by weight, based on the solids content of the mixture, of aluminum stearates and subsequently heated with expansion and crosslinking.
